(19) United States
(12) Patent Application Publication
(10) Pub. No.: US 2018/0276350 A1
(43) Pub. Date: Sep. 27, 2018

(54) MESSAGING SECURITY

(71) Applicant: Netiqet Labs Ltd, London (GB)

(72) Inventor: Richard Land, London (GB)

(21) Appl. No.: 15/768,620

(22) PCT Filed: Oct. 17, 2016
(86) PCT No.: PCT/GB2016/053209

§ 371 Date: Apr. 16, 2018

(30) Foreign Application Priority Data
Oct. 16, 2015 (GB) 1518327.0

(51) Int. Cl. G06F 21/10; G09C 5/00; G06F 21/62; H04L 9/08

(52) U.S. Cl. CPC G06F 21/10; G09C 5/00; G06Q 50/01; H04L 9/083; H04L 9/088; G06F 21/6209

(57) ABSTRACT

Disclosed herein is a method for obscuring, from a recipient, at least a portion of media and enabling the recipient to observe the obscured media when the recipient has permission, the method comprising processing at least a portion of a first version of media to produce a second version of the media such that the at least a portion of the media in the second version is obscured when observed, sending the second version for observation by a recipient when the recipient does not have permission to observe the first version, and sending data representative of the at least a portion of the first version of the media to enable the recipient to observe the at least a portion of the first version of the media when the recipient has permission to observe the first version.

### FIELD OF INVENTION

A method is disclosed herein that enables a user to obscure at least a portion of media from a recipient of the media and then enable the recipient to observe the obscured media when the recipient has permission. More specifically, but not exclusively, the method is useful for providing security when sending content across the internet including posting of social media messages online.

### BACKGROUND TO THE INVENTION

Messaging via social networks has become one of the main ways that people communicate with one another. However, social networks generally offer very little in the way of privacy and security of communications. This is particularly relevant when posting media such as text, photos, audio or video.

Some social networks have attempted to overcome this problem by allowing users to set up smaller networks within their social networking platform. Consequently, users can select their contacts with whom they want to share certain information. However, such social networks suffer from the problem of the complexity of management.

Another approach that is taken to security of internet communication is encryption. End-to-end message encryption works by building in a secret encryption/decryption algorithm into the client application. This algorithm uses virtual “keys”, each key is a string of alphanumeric characters that must be shared only between those who have permission to read a message.

To conceal a message, an encryption/decryption algorithm takes the original data as its input, e.g. a string of text or an area of pixels in a digital image, to be concealed (i.e. encrypted) plus a “key”. The encryption/decryption algorithm is then able to transform the original data into a new “scrambled” form that, in effect, “conceals” original message. This is the encryption process.

The exact form of the scrambled version is completely dependent on the combination of the algorithm, the key and the original data. As the algorithm remains constant, the only variables are the key and the original data. The “scrambling” (or encryption) process is not random. If the operation is repeated with the same original data and the same key, the resulting output will be identical.

The operation to reveal the concealed parts of the messages reverses this process. The concealed (encrypted) data is fed into the decryption algorithm, which is also built into the client application, along with the appropriate key, i.e. the specific key used to encrypt the data, and the algorithm can convert (decrypt) the data back into its original form, i.e. the content is revealed.

In order for the decryption to work, the concealed (encrypted) data must not have changed in any way from how it was output from the encryption algorithm. Even the slightest change in the encrypted data, e.g. one letter or one pixel, will render the decryption useless and the data will remain concealed. In other words, the encrypted data must remain immutable. This immutability would be compromised with any form of media other than text as if the encrypted medium is subject to a change in size or any form of irreversible compression. Since there are likely to be circumstances that require either or both of these for the sake of bandwidth or stage optimisation, this may have the effect of rendering end-to end encryption useless.

While encryption based approaches to providing security to messaging can work well for direct messaging communications, they introduce a security risk if utilised when posting to a public blog or social network. When an encrypted message is publically posted it exposes the system to hackers who depend on analysing, usually via automated processes, a very large number of messages using the same encryption method in order to determine how to decrypt the messages. Such systems are therefore exposed to a high risk of malicious, automated attempts to “crack the code”. Code cracking can be particularly effective when used to analyse large volumes of text, where well understood word and letter frequency patterns can be used by code-breaking algorithms. The security of the whole system could be destroyed if hackers were then to release a “spoiler app” that could decrypt and therefore reveal all concealed public posts.

This security risk is exacerbated if, for reasons of clarity, usability and/or bandwidth/storage optimisation, the encrypted version of a message must remain precisely the same size as the unencrypted version. This is because the strength (and thus security) of an encryption/decryption scheme, is dependent on a non-symmetrical substitution of encrypted characters. The higher the number of characters substituted in the encrypted string, the stronger the encryption can be. A one-to-one (symmetrical) substitution scheme is likely to comparatively easy to compromise.

To date there have not been any successful attempts to solve the problem of security in social network posts. As such, this is still a very relevant problem that remains unsolved.

### SUMMARY OF INVENTION

In one implementation, a method is provided for obscuring, from a recipient, at least a portion of media and enabling the recipient to observe the obscured media when the recipient has permission, the method comprising processing at least a portion of a first version of media to produce a second version of the media such that the at least a portion of the media in the second version is obscured when observed, sending the second version for observation by a recipient when the recipient does not have permission to observe the first version, and sending data representative of the at least a portion of the first version of the media to enable the recipient to observe the at least a portion of the first version of the media when the recipient has permission to observe the first version.

The method may further comprise receiving instructions identifying the at least a portion of the first version. The step of generating the second version may further comprise identifying how to obscure the at least a portion of the first version. The at least a portion of the second version may be obscured by overwriting the at least a portion of the first version with different data. The at least a portion of the media in the second version may be fully obscured such that there is no similarity between the at least a portion of the first and second versions. The at least a portion of the media may be partially obscured such that there is a similarly between the at least a portion of the first and second version. The data representative of the at least a portion of the media may comprise all the first version of the media. The data representative of the at least a portion of the media may comprise the at least a portion of the first version only. The data representative of the at least a portion of the media may be data that enables the extraction of the at least a portion of the first version of the media from the second version of the media. The method may further comprise determining whether or not the recipient has permission to observe the first version of the media. The method may also further comprise determining whether or not the recipient has fulfilled a given condition and granting permission to observe the first version of the media accordingly.

The identifying how to obscure the at least a portion of the first version may include receiving metadata associated with the first version of media which specifies how to obscure the at least a portion of the first version.

The method may further comprise receiving, at a recipient, the second version of the media. The method may also further comprise receiving, at a recipient, the data representative of at least a portion of the first version of the media. In addition, the method may comprise defining a region at a first location of a display associated with the recipient. The method may comprise displaying, on the display, at least part of the second version of the media on the display outside of the region and displaying at least part of the data representative of the at least a portion of the first version of the media within the region.

The region can be controlled to a second location of the display by the recipient via a display input. The display may be updated to display the at least part of the second version of the media on the device outside of the region at the second location, and display at least part of the data representative of the at least a portion of the first version of the media within the region at the second location.

In another implementation apparatus comprising a memory and a processor, the memory storing computer readable code operable by the processor to perform any method disclosed herein is provided.

The apparatus may be a user device, a server, or a combination of a user device and a server.

In yet another implementation a method is provided for enabling a recipient of media in which at least a portion of the media is obscured to observe the obscured media when the recipient has permission, the method comprising, receiving, when a recipient does not have permission to view a first version of media, a second version of the media deriving from the first version, wherein at least a portion of the first version of the media is obscured in the second version when the second version is observed, and receiving, when the recipient has permission to observe the first version of the media, data representative of the at least a portion of the first version of the media that enables the recipient to observe the at least a portion of the first version of the media.

The at least a portion of the media in the second version may be fully obscured such that there is no similarity between the at least a portion of the first and second versions. The at least a portion of the media may be partially obscured such that there is a similarly between the at least a portion of the first and second versions. The data representative of the at least a portion of the media may comprise all the first version of the media. The data representative of the at least a portion of the media may comprise the at least a portion of the first version only. The method may further comprise combining the at least a portion of the media of the first version with all portions of the second version other than the at least a portion to recreate the first version. The data representative of the at least a portion of the media may be data that enables the extraction of the at least a portion of the first version of the media from the second version of the media. The method may further comprise extracting the first version of the media from the second version of the media using the data representative of the at least a portion of the media. The method may also further comprise fulfilling a given condition to obtain permission to observe the first version of the media.

The method may further comprise receiving, when the recipient does has permission to observe the first version of the media, the second version of the media. It may also comprise defining a region at a first location of a display associated with the recipient. It might also comprise displaying at least part of the second version of the media on the display outside of the region and displaying at least part of the data representative of the at least a portion of the first version of the media within the region.

In a further implementation a user device comprising a memory and a processor, the memory storing computer readable code operable by the processor to perform any method disclosed herein is provided.

In yet another implementation computer readable media implementable on a computer system and operable, in use, to perform any method or any part of any method disclosed herein is provided.

### BRIEF DESCRIPTION OF THE DRAWINGS

Exemplary arrangements of the disclosure shall now be described with reference to the drawings in which:

FIG. 1 illustrates a system for implementing secure messaging;

FIG. 2 illustrates a process for generating a concealed message; and

FIG. 3 illustrates a process for revealing the original message from the concealed message.

Throughout the description and the drawings, like reference numerals refer to like parts.

### SPECIFIC DESCRIPTION

A system and method is disclosed herein which is a form of internet-based messaging and public social network consisting of a dedicated server infrastructure connected via the internet to multiple client applications on various handheld and desktop devices.

The client applications allow for the creation and sending of various forms of media (e.g. text, emoticons, image, video, audio) in a private message or public post, as well as receiving and viewing of that message or post, all via the dedicated, internet-based secure server infrastructure. The system described is intended for use in both public posting to a dedicated social network and for sending and receiving private messages.

The whole or a part of that message can be concealed (i.e. made “secret”) in such a way that only a recipient who is in possession of a special, software-based virtual “key” can reveal the concealed message or parts of the message. The system works by sending a first version of the message with certain data concealed, and then when the recipient of the message shows that they are in possession of a virtual key, a second version of the message is transmitted without the data concealed. Consequently, security is provided to messaging because certain data forming part or a whole of a message is only transmitted once a recipient has an appropriate key. This system is referred to herein as the Pseudo Encryption System (PES).

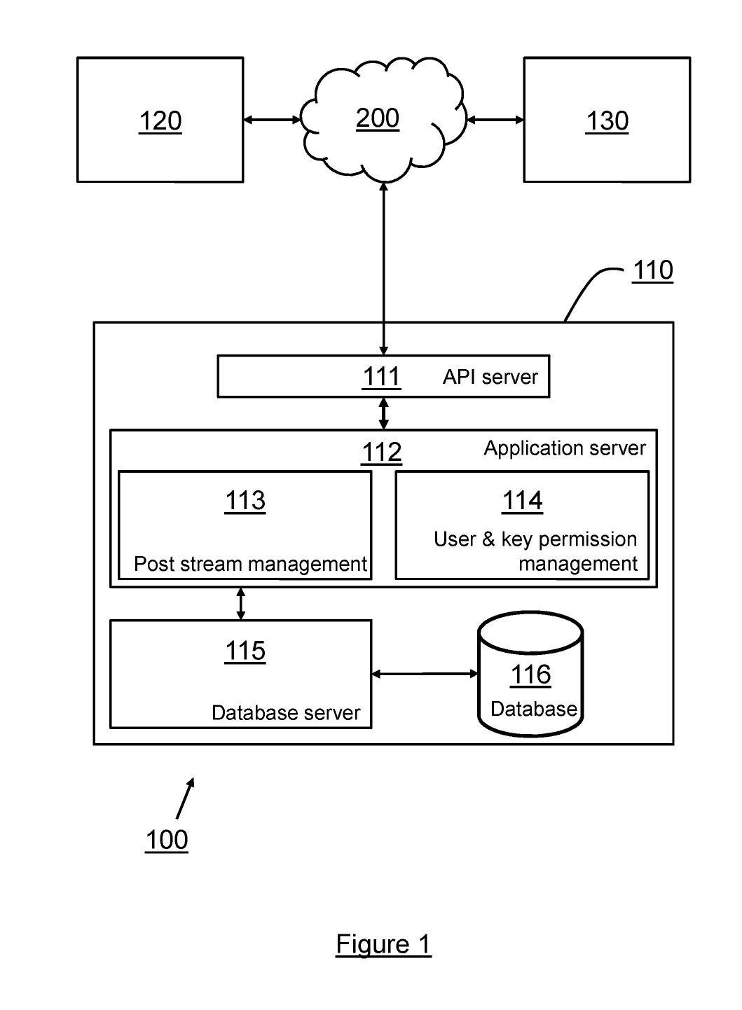

The structure of the PES 100 shall now be explained with reference to FIG. 1. A server 110 manages the processes of the PES. In FIG. 1, two user devices 120, 130 associated with respective users are illustrated for simplicity of explanation. In practice, there will be a large number of users of the PES.

Each user device 120, 130 comprises a memory having PES user software installed in the memory in the form of an app and a processor arranged to run the app. Within the PES user app each user is able to create messages to be posted on social media and set associated security relating to the messages, as well as receive and view both concealed or obscured versions of the messages and revealed or unobscured versions of the messages. Each user device 120, 130 may further comprise a display for displaying a user interface of the software and therefore also for displaying the concealed or revealed versions of the messages.

The server 110 comprises an API server 111, which acts as an external interface for the server 110. All communications in and out of the server pass through the API server 111 to the Application server 112, which runs the application and comprises a post stream management unit 113 and a user and key permission management unit 114. The post stream management unit 113 manages posts that are created by and received from a user such that messages can, for example, be posted to social media, but with the security of the message maintained. As such, the server 110 is capable of posting to social media on behalf of users. The user and key permission management unit 114 manages different users' permissions to view certain messages. Finally, the database, which is in communication with the application server 112 stores all of the data necessary for the operation of the Application server 112.

The user devices 120, 130 and the server 110 communicate with one another over network 200, which in this exemplary arrangement is the internet. In the PES, all communication and data transfer between the server 110 and the client apps on the user devices 110 use online banking grade security safeguards including 256 bit SSL encryption.

A process of creating a concealed message, posting the concealed message, determining if a user has permission to view a revealed version of the concealed message and then revealing the concealed message when the user does have permission shall now be discussed in detail. In this exemplary process, user device 120 is the sender of the message and user device 130 is the recipient of the message.

The core of the PES is efficient, secure and low redundancy storage and retrieval of both the original data and the “concealed” version.

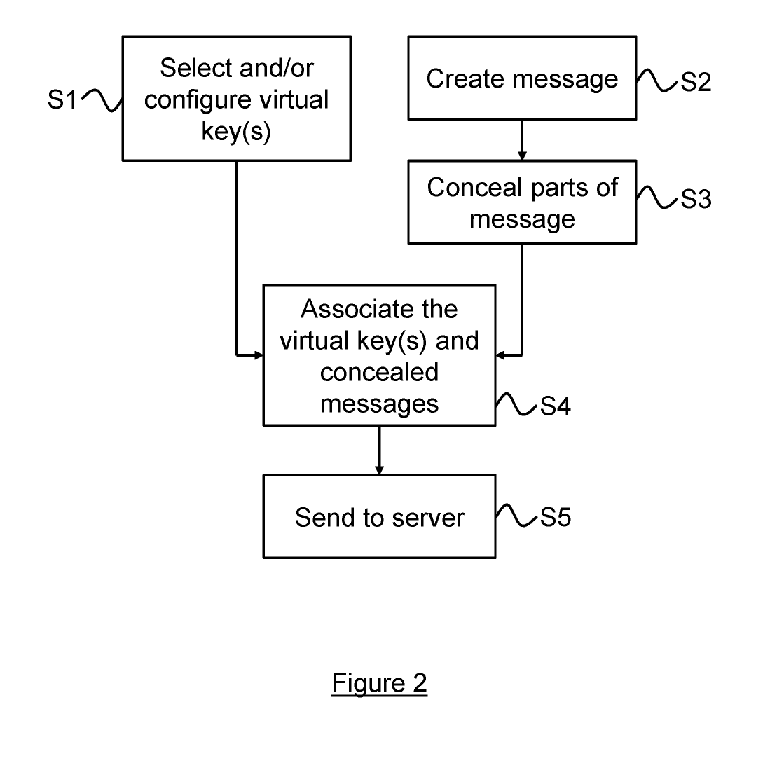

The process of creating a message shall firstly be discussed with reference to FIG. 2.

In order to create a message with some concealed elements, the user creating the message must select and configure the key or keys associated with the specific message concealment (i.e. the “secret”) that defines the access rights for anyone who encounters a message or post containing some concealed elements. This is carried out by the user in step S1. The user has a number of different options:

1. Single Use Key—the secret is locked for all users, until specific permission granted. In this arrangement, a user encountering the message or post containing the concealed elements is initially “locked out” but, in some circumstances, they may send an access request to the sender or poster. If a sender/poster receives such a request, they have the option to “lend” the requester a “Single Use Key”. This virtual key grants permission to the requester to reveal the concealed elements of this specific message. This is “Single Use” as the requester is only granted permission to the one specific secret, i.e. concealed elements, and no others. Once the requester has revealed the secret with a Single Use Key, the key cannot be used to reveal any further secrets and the requester may not pass the key on to anyone else. Note that in the case of Single Use Keys, the “key metaphor” may possibly be hidden from the user.

2. Multi Use Key—the secret is locked for all users except those that have been granted or acquired a virtual “Multi Use Key” (see more detail below). In this arrangement, a user encountering the message or post containing the concealed elements is initially “locked out” unless they have already been given a virtual Multi Use Key. Once they have a Multi Use Key they may use it to reveal any secrets associated with that key and, depending on the sharing permissions attached to the key, they may be able to pass the key on to others. In some circumstances, they may be able to send a request for a Multi Use Key to its creator or owner. The creator of a Multi Use Key can associate the key with multiple secrets and they can choose to send the key to multiple users. This enables the creator of such keys to control which groups of people have access to which secrets. They can associate more than one Multi Use Keys to a message containing a secret. They may also configure the key with various values, including different distribution and sharing options, such as::
1. Free access—whoever encounters the key can use it. It may be possible, for example, to “find” a free access key that a user has made available to anyone who visits their profile page.
2. Must be given to specified recipients, but can be passed on to other users.
3. Must be given to specified recipients, but cannot be passed on to other users.

They may also be able to customize a key in various ways:
Name the key.
Select a colour for the key to be displayed in the user interface of the software used on the user devices 120,130.
Select an “animation style”, i.e. the user may choose a variety of animated patterns to decorate their keys.
Select a “reveal style”, i.e. the way in which the concealed data is revealed, for example it could suddenly appear as soon as the key is acquired or it could fade into appearance.

3. Challenge Keys—the secret is locked for all users, until they successfully beat challenge set by poster/sender of the secret. In this arrangement, a user encountering the message or post containing the concealed elements is initially “locked out” but they are presented with a challenge that they must beat in order to reveal the secret. Challenges can be associated with both Single Use Keys and Multi Use Keys so that if the user beats the challenge they are granted a either one-off permission to reveal the specific secret (via a Single Use Key) or permission to reveal any secrets associated with a Multi Use Key.

Once created, the data associated with the key(s) is securely written to the key database where it is allocated unique identifier(s). At the same time the user profile data is updated in the user database, allowing the new key(s) to be located by querying the user data.

The user then creates the message to be concealed at step S2. The creation of a message which is concealed or a message comprising at least a part thereof which is concealed shall now be described.

The PES allows a user to create messages that contain a variety of media, including:
Text
Emoticons
Images
Video & animation
Audio

These media can be combined in a single message. In some cases, for example for images, video and audio, the media are initially displayed within the message in a “thumbnail” form and are only fully displayed or played back when activated by the message recipient. Some media types (e.g. photos) can be organized into collections within a single message.

Firstly, at step S2, the user creates the unconcealed message using the user device 120 containing one or more different types of media. This is the first version of the message. The user may use media stored on the user device 120 or may use media stored in cloud storage. Alternatively, the user may create the media there and then specifically for the message.

A user may then, at step S3, conceal, i.e. make secret or obscure, any part of any of the media within the message. A second version of the message is thereby created. For two dimensional, static media such as blocks of text or emoticons and images, the edit mode enables the user to select an area of the original media, e.g. a string of words or an area of a picture, and conceal it. For time-based media, such as audio and video and animation, the edit mode enables the user to scrub backwards and forwards through the medium and select a sequence to conceal. This concealment operation can be applied to other parts of the same media element. It is noted that in the case of video and animation, the concealment may only cover a selected sub-area of each video frame. The selected sub-area may vary on a frame-by-frame basis, for example to track a moving object or subject within the video or animation.

The user can select from a library of alternative “concealment effects”. For example:
The original text may be concealed by substituting “random” scrambled letters or by “random” words.
Text, Images, Emoticons and Video and animation may be concealed by various blurring, pixelation, or substituting various image overlays.
Audio may be concealed by various forms of distortion or by substituting alternative audio recording or sound effects.

During the creation and editing process, the user may reverse any concealment they have already done.

Once the concealment is completed, the user device has an original unconcealed message and a concealed message stored on it.

The virtual keys(s) selected and configured at step S1 are then linked with the unconcealed and the concealed messages at step S4. At any time during the creation and edit process, the user may re-select and re-configure keys(s) to link to the message.

Once the content and concealment is complete and the virtual keys(s) have been selected and configured, the user may send the message. In the case of private messaging, the user will either be replying to a message or they will select recipients. In the case of public posting, this step is not required.

After seeing a preview of what the message will look like to its readers, the user presses send. At this point the client application performs a series of operations to format the “message package” ready to send to the server, as shown by step S5. Some of the core components of the message package are:
The “secretised” or concealed message, which consists of:
   all the various media components that make up the whole message with any “concealment effects” applied. In the case of images, video and audio, the concealment effects are “rendered” or “baked-in” to the various media elements. In the case of text, the original words have been entirely replaced by the concealing substitutes.
   The formatting data that arranges the components into the layout intended by the creator.
The “original” message (delta compressed). By storing only the “delta” (i.e. “differences”) between the original and the concealed data, the system ensures that redundant data transmission and storage is kept to a minimum.
The data consists of:
   all the fragments of original message that were altered by the concealment effects applied by the user.
   The positional and scaling data that enables the original fragments to accurately replace the concealed portions of the secretised message. The positional data can take the form of: character counts, pixel counts or X,Y coordinates in the case of text blocks, images and video; or timing points, e.g. “In time”, in the case of time-based media such as audio and video.
Key I D(s)
Sender ID.
Recipient IDs (in the case of private messages).

Once the message package is ready, it is securely written to the server. The message package is then stored on the server 110.

In response to receiving the message, the server can be assigned the concealed (secretised) and revealed (original) messages respective IDs. These are then sent back to the user device and the user device can use these IDs to identify the concealed and revealed content by including the IDs in a message or post.

In an arrangement in which video data is included in the message or post, sending a concealed version and a revealed version of the content may use a large bandwidth of the communication channels to the server. The user device may therefore instead send just the original video data and concealment metadata instead of the concealed video data. In such a case, the concealment metadata contains parameters or directions how the original video should be concealed. This metadata can be produced during step S3 described above when the user inputs how the video should be concealed.

After the server receives the original video data and the concealment metadata from the user device, the server then creates the concealed video using the original video data and the concealment metadata. This step may be done on a processing device associated with the server. The function of the concealment metadata can be established by the server and/or user device applications prior to the sending of the message so that the server can interpret the metadata and perform the correct concealment of the video data. As an example, the concealment metadata can include the coordinate position of a concealment area and the size of the concealment area for a number of individual frames. The concealment metadata can also include the style of concealment performed on the concealment area. The concealed video data can be produced by using the concealment metadata with a real-time graphics filter operating on a graphics processing unit (GPU).

The server can assign an ID to the concealed video data and sends this back to the user device along with an assigned ID for the original video data. The user device can include these IDs when creating a post or message.

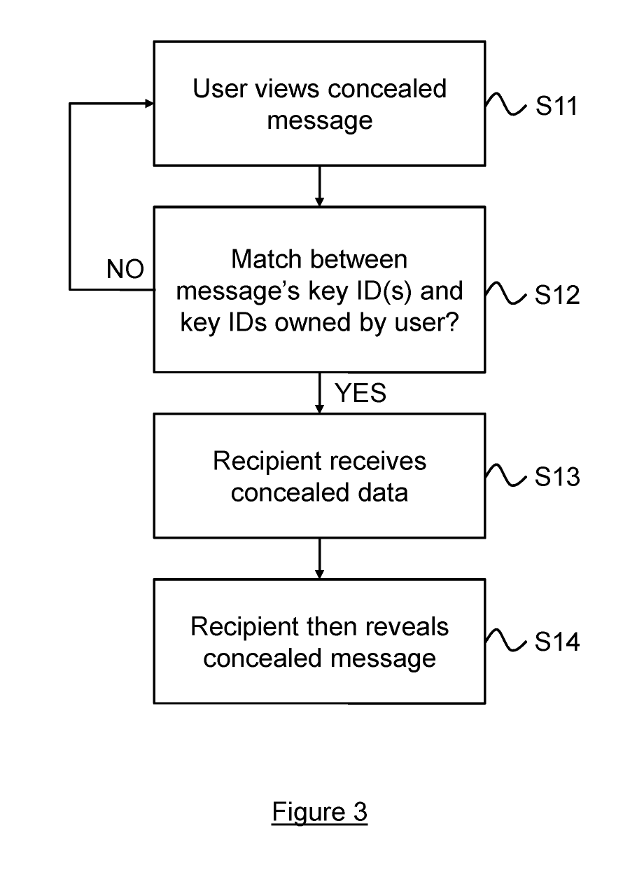

The process of observing a concealed message and revealing the concealed message or components of the concealed message shall now be discussed with reference to FIG. 3.

At step S11 a user associated with user device 130 encounters a message with concealed secrets either via a stream of public posts or via a direct message.

The client app on the user device 130 queries the backend database with some specific search criteria, e.g. user's ID, message ID, time/date range, sender's ID and/or other search criteria etc, that result in the recipient user being able to see the message containing concealed secrets.

The client app then, at step S12, queries whether there is a match between the key ID of the message and the key IDs owned by the recipient (i.e. the recipient has been given one or more Multi Use Keys associated with the message).

If there is no match between the message's key ID and the key I Ds owned by the recipient, then the backend reports to the client that the concealed secrets in the message are locked. In other words, a user receives a secretised message but does not have any appropriate Multi Use Keys key for this message. Consequently, the user is still only able to view the concealed message and it is only the secure “secretised” message that is available at the recipient's client app on the user device 130. Within the recipient's client app, the message is displayed with all the secretised elements concealed. Depending on the key type, the user may opt to send a request for the key from its owner. Various graphical elements and buttons within the GUI of the app inform the user of the messages locked status and enable appropriate actions to be taken. In alternative arrangements in which the secret is simply locked, the user may be able to send a request to the sender of the secret asking to reveal the secret. In such an arrangement a specific key is not required.

When a message is encountered in a user's client app, the recipient may already have the appropriate Multi Use key. In this case, the application server does find a match between the message's key ID and the key IDs owned by the recipient and the application server compiles a message package consisting of the “secretised” message plus the delta compressed original messages fragments, as shown at step S13. All the data is securely sent to the recipient's client app.

Within the recipient's client app, the message is displayed with all of the secretised elements concealed. Because the recipient has the appropriate key, they can opt to perform certain actions that will reveal any concealed parts of the message, in a variety of “reveal styles” that are determined by the nature of the concealed media and parameters associated with the key. Various graphical elements and buttons within the GUI will inform the user that they are able to reveal the message's secrets and enable them to take appropriate actions. This revealing process is shown at step S14.

In effect, the fragments of the original message are aligned precisely over their concealed counterparts but initially they are not displayed. When the user applies a “reveal” tool to the concealed area, a transition from concealed to revealed will occur around the location selected by the user, which may be animated if defined as such when the message was created. The precise nature of the reveal is dependent upon a number of factors including the type of medium, the conceal style used, the reveal style associated with the key and whether the medium is:
Two dimensional, static—e.g. text and images.
Two dimensional, dynamic (time based)—e.g. video and animation.
Dynamic (time based only)—e.g. audio.

A process of revealing concealed parts of a message or post shall now be discussed.

In some arrangements, the client app on the recipient's user device 130 has both a revealed user interface view and a concealed user interface view. The revealed and concealed user interface views may be stored on the memory of the user device 130. The concealed user interface view includes the message or post which the secretised elements concealed and the revealed user interface view includes the message or post with at least some of the secretised elements revealed. For example, the revealed user interface view may include the original message or post without any elements concealed.

The reveal style can therefore define the mechanism by which the user interface of the user device 130 transitions between the concealed user interface view and the revealed user interface view. The concealed user interface view and revealed user interface view are formatted to match each other regarding the content displayed, arrangement and alignment of features so that there can be a smooth transition between the two views.

An example of the mechanism to reveal concealed content is a “reveal lens”. A reveal lens is a region of a display of the user device 130 which can be controlled by a user input, for example by dragging the reveal lens across the display of the user device 130. As an example, the reveal lens may be a circular region of the display. The view produced on the display of the user device is a combination of the revealed and concealed user interface views. Within the region defined by the reveal lens, the revealed user interface view is displayed. Outside of the region defined by the reveal lens, the concealed user interface view is displayed. In this way, only a portion of the concealed content on any post will be revealed at any one time. Before the reveal lens is used, by default the concealed user interface view is displayed and therefore a user can explore the user interface using the reveal lens to uncover concealed parts of the message or post which the user has permission to view.

If a user device does not have permission to view the content of a post, the concealed post ID is used to identify the post with content concealed (that is, the secretised message/post) and the user device downloads this concealed post. This is then formatted to fit into both the revealed and concealed user interface views. For example, this may have to be formatted to match other posts in a post feed. As the user does not have permission to view parts of the content in this post, when the reveal lens passes across the post, there will be no effect. This is because the concealed post is displayed in both the concealed and revealed user interface views.

On the other hand, when the user device does have permission to view content which has been concealed, the reveal lens will have the effect of revealing content because the revealed and concealed user interface views will be different. The way in which the revealed and concealed interface views are established may vary depending on what type of content the post contains.

If the post includes text, the recipient user device 130 downloads, via the user device app to the memory, both the revealed and concealed posts as identified by the IDs assigned to the revealed and concealed content when it was uploaded to the server by the sender user device 120. The revealed content is formatted into the revealed user interface view, which may also include one or more other posts of various medium types. The concealed content is formatted into the concealed user interface view, which includes the respective posts, concealed where appropriate according the user device permissions, to match the revealed user interface view. When the reveal lens passes across the display of the recipient user device 130, it shows the revealed content of the revealed user interface view within the reveal lens region and outside of the reveal lens region; the content is concealed according to the concealed user interface view.

If the post includes image data, the recipient user device 130 downloads, via the user device app to the memory, both the revealed and concealed posts as identified by the IDs assigned to the revealed and concealed content when it was uploaded to the server by the sender user device 120. In a similar manner to text content described above, the revealed and concealed post are formatted and integrated into the concealed and revealed user interface views respectively. The revealed image data may only include the parts of the original image that were concealed in the original image. In this situation the revealed image data will be formatted into the revealed user interface view with the rest of the original image data, that is the parts of the original that were not concealed, taken from the concealed image.

If the post includes video data, there may be a limited amount of bandwidth which makes downloading both the concealed and revealed videos undesirable or impractical. In this situation, the revealed video data can be identified by the ID assigned when the video data was uploaded by the sender user device 120 and this can be downloaded to the recipient user device 130. The recipient user device 130 also downloads concealment metadata and performs the concealment on the video data to produce the corresponding concealed video data as defined by the sender user device 120. The downloaded video data is used to provide the audio for the video displayed on the recipient user device 130 and to sync revealed and concealed user interface view videos to the audio. For each frame, at a given timeslot of the video data, the frame image is sent to a real-time graphics filter with the concealment metadata and the concealment effects are applied to the frame and the resulting concealed frame included in the concealed user interface view. This concealed frame then replaces the previous frame from the previous timeslot. The revealed frame is also included in the revealed user interface view. This process is repeated by the real-time graphics filter for each frame as the video plays. As the reveal lens moves across the display of the recipient user device 130, it displays the revealed user interface view inside the region of the reveal lens whereas outside the reveal lens the concealed user interface view remains visible.

It is also possible for the position of the reveal lens to also be provided to the real-time graphics filter, so that only the region outside of revealed lens is processed for concealment. This is because, as each frame is being processed sequentially there is no need to conceal part of the video within the reveal lens as this will not be used. This approach reduces the processing required at the recipient client device 130. As less processing is required for each frame at each timeslot, this also reduces latency effects between the video and the audio, for example.

In some circumstances, the recipient may not have the required key when initially viewing the concealed message. However, the user may later acquire the key allowing the user to reveal the message's secrets. This can occur when the recipient finds or is sent the key when:
the key owner sends the key to the message recipient, for example they may have been prompted to do so via a specific “key request” message. In this case, the action is initiated by the key sender. The key sender's client app will send an update to the backend database containing the recipient's ID and the key ID. The key ID records for the key recipient will be updated with the new key ID and a notification will be sent to the recipient's client app.
the recipient has located the key elsewhere within the PES ecosystem. In this case, the action is initiated by the recipient. The recipient's client app will send an update to the backend database containing the recipient's ID and the key ID. The key ID records for the key recipient will be updated with the new key ID and a notification will be sent to the recipient's client app.

In both cases, when the recipient's client app next refreshes, various indications in the GUI will change to indicate that the user may now reveal any secrets in messages associated with the key that has just been received. In some circumstances the backend server will send a push notification to the recipient's client device, that may make changes to various indications in the client operating system and app.

In an alternative arrangement, rather than a recipient being issued with a normal key for revealing the concealed content, the recipient is issued with a challenge key. With a challenge key a user is obliged to complete a “challenge” before the key will reveal a secret. The challenge might be successfully answering a certain question, or going to a specific location in order to enable the information revealed. Once a challenge has been successfully completed, the key's permission status changes for that user, granting the user access to the single secret associated with the key (in the case of a Single Use Key) or access to any secrets associated with the key (in the case of a Multi Use Key). Technically, the key keeps the same identity but a flag is changed from “Challenge” to “Normal”.

While the above arrangements discuss a specific way in which the system is managed between a user, recipient and server, it will be appreciated that the system could be arranged to work in various different ways. The creation and sending of messages and content may be split in various ways between the user device and server. In some cases the server may not even be required at all. Some examples of such alternative arrangements are discussed below.

It will be appreciated that in other arrangements the user device may be used instruct the server and the message itself is then constructed on the server. The user may then just see a representation of the message on the user device 120.

In further arrangements various user devices may be used by a user, the user being identified by login information.

In other arrangements, the server may not be required. In particular, the creator of the message may manage authorisation to view the secret portion(s) of the message. In addition, all communications in such arrangements are directly between the user that has created the message and the recipient(s).

In yet further arrangements all of the messaging may take place on a single device with users identified by separate login information.

In some arrangements, the server simply manages permissions. In other arrangements, the server also stores the original image to provide to recipients that have permission.

While the arrangement discussed above with reference to the Figures only sends the delta of the original image through to the recipient, i.e. the difference between the original and secret image, in some arrangements the whole original image may be sent to a recipient when they are permitted to view the original. This reduces the amount of processing required at the user device of the recipient because now image combination is required.

In other arrangements, data representative of the original message or data concealed in the original message is sent. For example, this may be data that enables the extraction of the necessary data from the concealed message, or just a representation of the data in a form other than the raw data.

The key need not be generated by the user device. Instead, the key could be generated by the server and simply selected from the user device. In such an arrangement the key and message may be combined at the server rather than at the user device.

In some arrangements the keys that a user has may be stored on the user device. In other arrangements the keys may be stored on the server only. In the latter case, the server determines if a particular user has permission to view an original message and sends data to the user to enable the user to view the original message.

Arrangements discussed herein advantageously overcome the problems of encryption based methods. For example, it does not matter if the messages are changed at all during transmission, e.g. by compression or such like.

The system also allows for a whole message or a part of a message to be obscured. When only a small part of a message is obscured using encryption techniques this vastly reduces the security level. However, in the present system the security level remains the same irrespective of how much of the message is obscured.

The system disclosed herein is highly secure requiring authorisation from a creator of the message for viewing of the message.

Furthermore, the system disclosed herein allows for interesting, playful, varied and innovative “concealment effects” to be utilised. For example: Random word or letter substitution, blurring, pixelation, distortion, substitution of media etc. Further playful elements may be added by the use of the “challenge key” arrangement.

The various methods described above may be implemented by one or more computer program products or computer readable media provided on one or more devices. The computer program product or computer readable media may include computer code arranged to instruct a computer or a plurality of computers to perform the functions of one or more of the various methods described above. The computer program and/or the code for performing such methods may be provided to an apparatus, such as a computer, on a computer readable medium or computer program product. The computer readable medium may be transitory or non-transitory. The computer readable medium could be, for example, an electronic, magnetic, optical, electromagnetic, infrared, or semiconductor system, or a propagation medium for data transmission, for example for downloading the code over the Internet. Alternatively, the computer readable medium could take the form of a physical computer readable medium such as semiconductor or solid state memory, magnetic tape, a removable computer diskette, a random access memory (RAM), a read-only memory (ROM), a rigid magnetic disc, and an optical disk, such as a CD-ROM, CD-R/W or DVD.

An apparatus such as a computer may be configured in accordance with such code to perform one or more processes in accordance with the various methods discussed herein. Such an apparatus may take the form of a data processing system. Such a data processing system may be a distributed system. For example, such a data processing system may be distributed across a network. Some of the processes may be performed by software on a user device, while other processes may be performed by software on a server, or a combination thereof.

1. A method, applied in a social media platform, for obscuring, from a recipient, at least a portion of media and enabling the recipient to observe the obscured media when the recipient has permission, the method comprising:
processing at least a portion of a first version of media to produce a second version of the media such that the at least a portion of the media in the second version is obscured when observed;
sending the second version for observation by a recipient when the recipient does not have permission to observe the first version; and
sending data representative of the at least a portion of the first version of the media to enable the recipient to observe the at least a portion of the first version of the media when the recipient has permission to observe the first version.

2. The method of claim 1, further comprising receiving instructions identifying the at least a portion of the first version.

3. The method of claim 1, wherein the step of generating the second version further comprises identifying how to obscure the at least a portion of the first version.

4. The method of claim 3, wherein the identifying how to obscure the at least a portion of the first version includes receiving metadata associated with the first version of media which specifies how to obscure the at least a portion of the first version.

5. The method of claim 3, wherein the at least a portion of the second version is obscured by overwriting the at least a portion of the first version with different data.

6. The method of claim 1, wherein the at least a portion of the media in the second version is fully obscured such that there is no similarity between the at least a portion of the first and second versions.

7. The method of claim 1, wherein the at least a portion of the media is partially obscured such that there is a similarly between the at least a portion of the first and second version.

8. The method of claim 1, wherein the data representative of the at least a portion of the media comprises all the first version of the media.

9. The method of claim 1, wherein the data representative of the at least a portion of the media comprises the at least a portion of the first version only.

10. The method of claim 1, wherein the data representative of the at least a portion of the media is data that enables the extraction of the at least a portion of the first version of the media from the second version of the media.

11. The method of claim 1, further comprising determining whether or not the recipient has permission to observe the first version of the media.

12. The method of claim 1, further comprising determining whether or not the recipient has fulfilled a given condition and granting permission to observe the first version of the media accordingly.

13. The method of claim 1, further comprising:
receiving, at a recipient, the second version of the media;
receiving, at a recipient, the data representative of at least a portion of the first version of the media;
defining a region at a first location of a display associated with the recipient; and
displaying, on the display, at least part of the second version of the media on the display outside of the region and displaying at least part of the data representative of the at least a portion of the first version of the media within the region.

14. The method of claim 13, wherein the region can be controlled to a second location of the display by the recipient via a display input, wherein the display is updated to display the at least part of the second version of the media on the device outside of the region at the second location, and display at least part of the data representative of the at least a portion of the first version of the media within the region at the second location.

15. Apparatus comprising a memory and a processor, the memory storing computer readable code operable by the processor to perform the method of claim 1.

16. The apparatus of claim 15, wherein the apparatus is a user device, a server, or a combination of a user device and a server.

17. A method, applied within a social media platform, for enabling a recipient of media in which at least a portion of the media is obscured to observe the obscured media when the recipient has permission, the method comprising:
receiving, when a recipient does not have permission to view a first version of media, a second version of the media deriving from the first version, wherein at least a portion of the first version of the media is obscured in the second version when the second version is observed; and
receiving, when the recipient has permission to observe the first version of the media, data representative of the at least a portion of the first version of the media that enables the recipient to observe the at least a portion of the first version of the media.

18. The method of claim 17, wherein the at least a portion of the media in the second version is fully obscured such that there is no similarity between the at least a portion of the first and second versions.

19. The method of claim 17, wherein the at least a portion of the media is partially obscured such that there is a similarly between the at least a portion of the first and second versions.

20. The method of claim 17, wherein the data representative of the at least a portion of the media comprises all the first version of the media.

21. The method of claim 17, wherein the data representative of the at least a portion of the media comprises the at least a portion of the first version only.

22. The method of claim 21, further comprising combining the at least a portion of the media of the first version with all portions of the second version other than the at least a portion to recreate the first version.

23. The method of claim 17, wherein the data representative of the at least a portion of the media is data that enables the extraction of the at least a portion of the first version of the media from the second version of the media.

24. The method according to claim 23, further comprising extracting the first version of the media from the second version of the media using the data representative of the at least a portion of the media.

25. The method of claim 17 further comprising fulfilling a given condition to obtain permission to observe the first version of the media.

26. The method of claim 17, further comprising:
receiving, when the recipient does has permission to observe the first version of the media, the second version of the media;
defining a region at a first location of a display associated with the recipient; and
displaying at least part of the second version of the media on the display outside of the region and displaying at least part of the data representative of the at least a portion of the first version of the media within the region.

27. A user device comprising a memory and a processor, the memory storing computer readable code operable by the processor to perform the method of claim 17.

28. Computer readable media implementable on a computer system and operable, in use, to perform the method of claim 1.

29. Computer readable media implementable on a computer system and operable, in use, to perform the method of claim 17.
